(19) United States
(12) Patent Application Publication
(10) Pub. No.: US 2024/0300983 A1
(43) Pub. Date: Sep. 12, 2024

(54) Method of Making Metal-Organic Frameworks With a Precursor and Crystallization Aid

(71) Applicant: ExxonMobil Technology and Engineering Company, Annandale, NJ (US)

(72) Inventors: Joseph M. Falkowski, Hampton, NJ (US); Mary S. Abdulkarim, Palisades Park, NJ (US)

(21) Appl. No.: 18/572,039

(22) PCT Filed: Jun. 23, 2022
(86) PCT No.: PCT/US2022/034738

§ 371 Date: Dec. 19, 2023

Related U.S. Application Data
(60) Provisional application No. 63/202,856, filed on Jun. 28, 2021.
(60) Provisional application No. 63/296,178, filed on Jan. 4, 2022.

(51) Int. Cl. C07F 7/00; B01J 20/22; B01J 20/30; B01J 31/16; B01J 37/03; B01J 37/04; B01J 37/08

(52) U.S. Cl. CPC C07F 7/003; B01J 20/226; B01J 20/3078; B01J 20/3085; B01J 31/1691; B01J 37/031; B01J 37/04; B01J 37/08; B01J 2531/48; B01J 2531/49

(57) ABSTRACT

Provided herein are methods of making a metal-organic framework comprising: combining a pre-ligand with a metal source to provide a plurality of solid reactants; adding a solvent to the plurality of solid reactants to form a reaction mixture, wherein at least 50 wt % of the reaction mixture are the plurality of solid reactants; heating the reaction mixture wherein the pre-ligand is converted to a ligand in the reaction mixture and the ligand reacts with the metal component; and cooling the reaction mixture to produce the metal-organic framework. The present methodologies are performed without dimethylformamide in the reaction mixture. The present methods may further comprise the step of adding a crystallization aid such as zinc oxide to the reaction mixture.

### CROSS REFERENCE TO RELATED APPLICATIONS

The present application claims priority to and the benefit of U.S. Provisional Application No. 63/296,178 filed on Jan. 4, 2022, and of U.S. Provisional Application No. 63/202,856 filed on Jun. 28, 2021, which are hereby incorporated by reference in their entirety.

### FIELD

The present disclosure is directed to methods of making metal-organic frameworks without the use of dimethylformamide (i.e., in the reaction mixture), and more particularly is directed to a method of making a metal-organic framework with a reaction mixture of at least 50 wt % solid reactants and a low amount of solvent.

### BACKGROUND

The scale up for the commercial manufacture of metal-organic frameworks is challenged by the need for toxic and costly organic solvents. In certain cases, water and/or other low-cost, benign solvents can be utilized. However, in many instances, the low solubility of organic ligands requires the use of polar aprotic solvents, such as dimethylformamide (“DMF”). Under these conditions, it is desirable to operate with a reaction mixture having the highest concentration of reactants as possible. This is challenging as certain reactions suffer from poor crystallinity of materials produced and/or loss of phase specificity at high concentrations which ultimately limits the application of the materials.

### SUMMARY

Provided herein are methods of making a metal-organic framework comprising: combining a pre-ligand with a metal source comprising a metal component to provide a plurality of solid reactants; adding a solvent to the plurality of solid reactants to form a reaction mixture; heating the reaction mixture; and cooling the reaction mixture to produce an insoluble portion and a soluble portion. At least 50 wt % of the total reaction mixture weight is the plurality of solid reactants. As the reaction mixture is heated, the pre-ligand is converted to a ligand in the reaction mixture and the ligand reacts with the metal component. The insoluble portion comprises a plurality of the metal-organic frameworks. Each metal-organic framework comprises a ligand and the metal component. Each of the method steps is performed without a formamide solvent, in particular the reaction mixture is free of a formamide, such as free of dimethylformamide. The present methods can further comprise the step of adding a crystallization aid to the reaction mixture with the solvent.

Also provided herein are methods of making a metal-organic framework comprising a plurality of tetravalent cations and a plurality of terephthalate linkers, comprising the steps of: combining a pre-ligand selected from esters of a terephthalate with a metal source comprising a tetravalent metal component to provide a plurality of solid reactants; adding a solvent comprising a monocarboxylic acid, optionally, a mineral acid, and, optionally, a crystallization aid comprising a divalent metal to the plurality of solids to form a reaction mixture having a mol ratio of monocarboxylic acid to (pre)ligand between 1:1 and 20:1; heating the reaction mixture to a temperature to between about 100° C. and about 220° C.; cooling the reaction mixture to produce an insoluble portion and a soluble portion; separating the insoluble portion from the soluble portion; and drying the insoluble portion to produce a plurality of the metal-organic frameworks. The crystallization aid comprises a divalent metal. The insoluble portion comprises a plurality of the metal-organic frameworks. Each metal-organic framework comprises the ligand and the metal component (the pre-ligand being converted to a ligand and the ligand reacting with the metal component, while heating of the reaction mixture). At least 50 wt % of the total weight percent of the reaction mixture is the plurality of solid reactants. Each of the steps of the present methodology is performed without a formamide solvent, in particular the reaction mixture is free of a formamide, such as free of dimethylformamide.

These and other features and attributes of the disclosed methods of the present disclosure and their advantageous applications and/or uses will be apparent from the detailed description which follows.

### BRIEF DESCRIPTION OF THE DRAWINGS

To assist those of ordinary skill in the relevant art in making and using the subject matter hereof, reference is made to the appended drawings, wherein:

FIG. 1 depicts powder X-ray diffraction pattern of samples described in Example 1 (comparative) and Example 2.

FIG. 2 shows the powder X-ray diffraction patterns of UiO-66 metal-organic frameworks before (upper curve) and after (below curve) calcination, made by the method described in Example 2 with 2 grams zinc oxide and 20 mL acetic acid. The arrows in FIG. 2 point to unreacted material present in the un-calcinated material.

FIG. 3 are isotherms of dimethyl terephthalate derived (“DMT-derived”) UiO-66 after water washing and 250° C. calcination (darkest); after a formate washing and 250° C. calcination (medium gray) as described in Example 2; and for a comparative method (light gray) described in Example 1.

FIG. 4 shows the powder X-ray diffraction pattern of UiO-66 synthesized from unpurified post-consumer polyethylene terephthalate (“PET”), as described in Example 3.

FIG. 5 shows the powder X-ray diffraction patterns of UiO-66 samples produced with dimethyl terephthalate (“DMT”) without the presence of DMF and of a ZnO crystallization aid, as described in Example 4.

FIG. 6 shows the powder X-ray diffraction patterns of UiO-66 samples produced with DMT and zinc oxide (“ZnO”) under different loadings of acetic acid, as described in Example 5.

FIG. 7 shows the powder X-ray diffraction patterns of EMM-32 synthesized at 70° C.

FIG. 8 shows powder X-ray diffraction patterns of EMM-32 synthesized at 70° C. and 100° C. after synthesis, and after solvent exchange and air drying.

FIG. 9A shows powder X-ray diffraction pattern of EMM-32 after freeze drying and activation at 150° C. under vacuum and a scanning electron micrograph of EMM-32 crystals.

FIG. 9B shows a nitrogen adsorption isotherm for EMM-32 after the metal-organic framework was benzene freeze dried and activated at 150° C. for 12 hours.

FIG. 10 is a thermogravimetric analysis (“TGA”) curve of EMM-32 showing decomposition at approximately 400° C.

FIG. 11 shows the powder X-ray diffraction patterns of EMM-32 where the synthesis was operated at a ligand concentration of 0.019 mol/l and 100° C.

FIG. 12 shows the powder X-ray diffraction patterns of EMM-32 synthesized at ligand concentrations of 0.035 and 0.060 mol/l. In each instance, the ligand to metal ratio was 1:1 and the temperature of the reaction was 100° C.

FIG. 13A shows the powder X-ray diffraction patterns of EMM-32 samples synthesized at concentrations ranging from 0.07 mol/l to 0.17 mol/l using optimized acetic acid to ligand ratio. Note the low signal intensity for samples made from 0.17 mol/l conditions shown in the top curve.

FIG. 13B shows the powder X-ray diffraction patterns for EMM-32 synthesized at ligand concentrations of 0.35 mol/l.

FIG. 14 shows the powder X-ray diffraction patterns of EMM-32 synthesized using zinc oxide as a crystallization aid.

FIG. 15A shows the powder X-ray diffraction patterns of EMM-32 samples using magnesium oxide as the mediator.

FIG. 15B shows powder X-ray diffraction patterns of EMM-32 samples using sodium acetate as a crystallization aid.

FIG. 16 shows the powder X-ray diffraction patterns of EMM-32 samples at 0.35 mol/l with zinc chloride and zinc acetate used as mediators.

FIG. 17 shows the powder X-ray diffraction pattern of EMM-71 synthesized as described in Example 6.

FIG. 18 shows the adsorption isotherm conducted at 77° K on EMM-71 as synthesized in Example 6.

FIG. 19 shows the powder X-ray diffraction pattern of EMM-71 synthesized as described in Example 7.

FIG. 20 shows the powder X-ray diffraction pattern of NH₂-EMM-71 synthesized as described in Example 8.

FIG. 21 shows the powder X-ray diffraction pattern of Zr-Fumarate synthesized as described in Example 9.

### DETAILED DESCRIPTION

Before the present compounds, components, compositions, and/or methods are disclosed and described, it is to be understood that unless otherwise indicated this disclosure is not limited to specific compounds, components, compositions, reactants, reaction conditions, ligands, catalyst structures, MOF structures, or the like, as such may vary, unless otherwise specified. It is also to be understood that the terminology used herein is for the purpose of describing particular embodiments only and is not intended to be limiting.

All numerical values within the detailed description and the claims herein are modified by “about” or “approximately” the indicated value, taking into account experimental error and variations.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, within a range includes every point or individual value between its end points even though not explicitly recited. Thus, every point or individual value may serve as its own lower or upper limit combined with any other point or individual value or any other lower or upper limit, to recite a range not explicitly recited.

For the purposes of this disclosure, the following definitions will apply:

As used herein, the terms “a” and “the” as used herein are understood to encompass the plural as well as the singular.

As used herein, a “metal organic framework” can be a mixed-metal organic framework or a metal-organic framework system or a mixed-metal mixed-organic framework system as described in PCT Patent Publication No. WO2020/219907.

As used herein, a ligand (also referred to as a “linker”) is a compound that bridges two or more metals (metal nodes) to form a coordination network in a metal-organic framework. The protonation status of the ligand can change during the course of the reaction and different protonation states of a ligand are collectively described as a single ligand.

As used herein, a pre-ligand or a precursor is a compound that participates in a chemical reaction to produce another compound and/or a compound from which a ligand is formed.

As used herein, the term “divalent” refers to an oxidation state of the divalent cation and not whether it is part of an overall charged molecule (for example, ZnCl₂ dissolved and not dissociated).

It is understood that, in any compound described herein having one or more chiral centers, if an absolute stereochemistry is not expressly indicated, then each center may independently be of R-configuration or S-configuration or a mixture thereof. Thus, the compounds provided herein may be enantiomerically pure or be stereoisomeric mixtures.

In addition, it is understood that, in any compound described herein having one or more double bond(s) generating geometrical isomers that can be defined as E or Z, each double bond may independently be E or Z or a mixture thereof. Likewise, it is understood that, in any compound described, all tautomeric forms are also intended to be included.

In addition, the compounds provided herein may also contain unnatural proportions of atomic isotopes at one or more of the atoms that constitute such compounds. For example, the compounds may be radiolabeled with radioactive isotopes, such as for example tritium (³H), iodine-125 (¹²⁵I) or carbon-14 (¹⁴C). All isotopic variations of the subject compounds, whether radioactive or not, are intended to be encompassed within the scope of present disclosure.

In addition, the compounds provided herein can contain differential protonation states depending on solution pH. All conjugate acids and bases of the compounds are intended to be encompassed within the scope of the present disclosure.

Metal-organic frameworks (“MOFs”) are constructed with a three-dimensional assembly of metal ions/metal cluster and organic ligands. Having high pore volumes, ordered structure and tunability, metal-organic frameworks are suitable for use in many applications such as photo catalysis, catalysis, separation and purification, gas/energy storage and sensing. High surface areas and high concentration of isolated metal ions enhances gas storage capacity and mass transportation.

Metal-organic frameworks comprise organic ligands (referred to sometimes as “linkers”) that bridge metal nodes (referred to as “secondary building units” or “SBUs”) through coordination bonds and can self-assemble to form a coordination network. Tunable topologies, either through isoreticular expansion or functionalization of the organic ligand/metal node, make metal-organic frameworks customizable for various different applications ranging from catalytic transformations to adsorption and separations to biomedical applications. Metal-organic frameworks have properties useful in industrial applications such as gas adsorption, gas separations, catalysis, heating/cooling, batteries, gas storage, sensing, and environmental remediation.

Stability of a metal-organic framework (“MOF”) can be attributed to strong interactions between ions of low polarizability such as carboxylates and trivalent metals. Stable metal-organic frameworks were initially relegated to phthalate-based MOFs derived from trivalent cations, namely Al³⁺, Fe³⁺, and Cr³⁺. Subsequently, other multivalent cations such as Zr⁴⁺, Hf⁴⁺, or Ti⁴⁺ were utilized to provide additional robust frameworks. A metal-organic framework UiO-66 was first discovered by reacting zirconium salts with linear dicarboxylic acids. Cavka, J. H. et al. (2008) “A New Zirconium Inorganic Building Brick Forming Metal Organic Frameworks with Exceptional Stability,” J. Am. Chem. Soc., v. 130(42), pp. 13850-13851. EMM-71, a metal-organic framework comprising a plurality of tetravalent cations and terephthalate linkers crystallized in a primitive cubic lattice, characterized by a high number of missing-cluster/node defects, has been described in U.S. Provisional Application No. 63/202,856, filed on Jun. 28, 2021.

In the metal-organic framework, the organic ligands bridge metal nodes (secondary building units, SBUs) through coordination bonds and within the MOFs, the metal ions form nodes that bind ligands together forming a repeating, cage-like structure. Due to a resulting hollow structure, MOFs offer large internal surface area.

In contrast to other porous materials, MOFs further offer unique structural diversity including uniform pore structures, atomic-level structural uniformity, tunable porosity, extensive varieties, and flexibility in network topology, geometry, dimension, and chemical functionality allowing for manipulation of framework topology, porosity, and functionality. This vast catalog of tunable topologies makes MOFs highly customizable, having applications ranging from catalytic transformations to adsorption and separations to biomedical applications.

MOFs are composed of both organic and inorganic components in a rigid periodic networked structure that is not readily accessible in conventional porous materials, e.g., purely inorganic zeolites. Various structures of MOFs can be synthesized depending on the kinds of metal ions and organic ligands. By making MOFs of different metal atoms and ligands, materials can be created that selectively absorb specific gases into tailor-made pockets within the structure. Metal-organic frameworks having high pore volumes, ordered structure, and seemingly infinite tunability have emerged as a new frontier of porous active materials for many applications. However, MOFs are relatively unstable, particularly when compared to traditional porous silicas and alumina.

Therefore, chemically and thermally stable metal-organic frameworks have been developed based on high-valent metals (Al/Cr/Fe³⁺ and Zr/Hf/Ti⁴⁺). For example, the zirconium metal-organic framework UiO-66 has been widely promoted due to its ease of synthesis, high stability, and readily tunable structure either through isoreticular expansion or simple functionalization of the organic ligand/metal node. Due to these benefits, researchers have attempted to devise green and scalable syntheses for this framework that obviates the need for toxic and flammable solvents.

Due to its thermal and chemical stability, the metal-organic framework, UiO-66 has been extensively studied for a myriad of applications and synthetized though many synthetic pathways, including continuous flow, mechanochemical, and primarily, solvothermal. Outside of some standalone examples where preconstructed molecular zirconium clusters were used to direct the synthesis of UiO-66, the plurality of synthetic conditions involves the reaction of a zirconium salt-often a chloride or oxychloride—with a linear dicarboxylic acid. UiO-66, the prototypical member in the UiO family, is constructed of terephthalic acid and was discovered in 2008. See Cavka, supra. Since then, dozens of functionalized derivatives as well as isoreticular analogs (those comprised of longer linear diacids such as 4,4′-biphenyldicarboxylic acid) have been studied. A common theme throughout the pantheon of synthetic conditions is the use of high-boiling aprotic solvents, with the bulk of the examples utilizing N,N-dimethylformamide (“DMF”). Coupled to the use of high-boiling aprotic solvents, modulators—in the form of monocarboxylic acid—are leveraged to meter reactivity and to improve the crystallinity of the resulting materials.

The requirement of potent solvents such as dimethylformamide (“DMF”) in the synthesis of metal-organic frameworks has hindered wide-spread commercialization. To date, several approaches have attempted to circumvent this limitation. For example, alternative synthetic conditions have included use of water dilution to mitigate the need for dimethylformamide (“DMF”) in the solvent mixture. Other alternative methods include the use of solubilizing groups such as amino or carboxy groups which can be appended to the terephthalate ligand to impart improved solubility. However, this approach increases the cost of starting materials and can serve to degrade materials properties such as lower crystallinity or lower intrinsic adsorption selectivity. Other methods utilize solvents which are less toxic, use bio-derived lactones as a metal organic framework precursor and/or use depolymerized polyethylene terephthalate (“PET”) as a ligand source. See, Zhou, L. et al. (2019) “Direct Synthesis of Robust hcp UiO-66 (Zr) MOF Using Poly(ethylene terephthalate) Waste as Ligand Source,” Micro. Meso. Mater., v. 290, pg. 109674; Dyosiba, X. et al. (2019) “Feasibility of Varied Polyethylene Terephthalate Wastes as a Linker Source in Metal-Organic Framework UiO-66 (Zr) Synthesis,” Ind. Eng. Chem. Res., v. 58, pp. 17010-17016. PET comprises two main components, namely benzene dicarboxylic acid (BDC), a building block in the synthesis of BDC-based metal-organic frameworks, and ethylene glycol. PET can be extracted using various techniques. BDC derived from PET wastes can then be applied in the green synthesis of functional metal-organic frameworks. Id.

Even these alternatives, however, still suffer from the need for a solvent recovery system on any commercial production line. Hence, despite efforts to avoid its use, DMF remains an important component in the synthesis of metal organic frameworks.

Lieb, A. et al. disclose the preparation of large pore vanadium (III) trimesate MIL-100(V) from a mixture of VCl₃ and triethyl-1,3,5-benzene tricarboxylate in water, at low solids concentration (about 20 wt %). See, Lieb, A. et al. (2012) “MIL-100(V)—A Mesoporous Vanadium Metal Organic Framework with Accessible Metal Sites,” Micro. Meso. Mater., v.15, pp. 18-23.

The current methodologies circumvent the need for DMF in the synthesis of metal-organic frameworks comprising metal ions of multivalent cations, in particular of tetravalent cations, such as zirconium, titanium, cerium and hafnium. The present methodologies also circumvent the need for large volumes of solvent by utilizing a pre-ligand (e.g., an ester of fumarate or an ester of a terephthalate) having high solubility in low volumes of solvent (e.g., water or acetic acid or any component present in liquid form in the reaction mixture described herein). Under reaction conditions, the pre-ligand converts to a ligand (e.g., fumaric acid or terephthalic acid or a derivative thereof) and reacts with the metal component to form a metal-organic framework. The present methods have the advantage of providing a synthesis where the metal-organic framework can be produced without any organic solvent except for possibly a monocarboxylic acid (e.g., acetic acid and other analogous solvents such as formic acid, propionic acid). In addition or in the alternative, the present methods may use a mineral acid (e.g., HCl and other analogous acids such as HBr). The present methods also have the advantage of using less solvent in the synthesis of the metal-organic framework. In particular, at most 1 weight equivalent of solvent (comprising said acetic acid, hydrochloric acid, etc. or a mixture thereof, and optional water) are combined with a plurality of solid reactants as opposed to between about 15 to about 35 weight equivalents used in a traditional Zr-MOF synthesis. Moreover, the present methods can offer the ability to operate at high space time yields, for instance at approximately 0.4 kilogram per liter per day (˜0.4 kg/L/day) in synthesis having a plurality of solid reactants greater than 50 wt %. In the present methods, a divalent metal source (e.g., zinc oxide) can be added to the synthesis to increase the degree of crystallinity of the metal-organic framework formed as well as to limit the presence of side phases.

Additionally, we have discovered that the present methodologies can utilize post-consumer plastics as acceptable reactants (pre-ligands). This was surprising as literature reports that these reactants resulted in a denser, lower surface area material. However, we discovered that this result was most likely due to high concentrations of formic acid utilized in the prior art and the inclusion of further organic solvent (e.g., acetone).

### Traditional Synthesis

Traditionally, metal-organic frameworks are prepared by reactions of pre-synthesized or commercially available linkers with metal ions. An alternative approach, referred to as “in situ linker synthesis,” specified organic linkers (linkers) can be generated in the reaction media in situ from the starting materials.

In synthesizing the metal-organic framework, organic molecules are not only structure-directing agents but as reactants to be incorporated as part of the framework structure. With this in mind, elevated reaction temperatures are generally employed in conventional synthesis. Solvothermal reaction conditions, structure-directing agents, mineralizers as well as microwave-assisted synthesis or steam-assisted conversions have also been recently introduced.

As referred to herein, the traditional synthesis is typically applied reactions carried out by conventional electric heating without any parallel reactions. In the traditional synthesis, reaction temperature is a primary parameter of a synthesis of the metal-organic framework and two temperature ranges, solvothermal and nonsolvothermal, are normally distinguished, which dictate the kind of reaction setups to be used. Solvothermal reactions generally take place in closed vessels under autogenous pressure about the boiling point of the solvent used. Nonsolvothermal reactions take place below, or at the boiling point under ambient pressure, simplifying synthetic requirements. Nonsolvothermal reactions can be further classified as room-temperature or elevated temperatures.

Traditional synthesis of metal-organic frameworks takes place in a solvent and at temperatures ranging from room temperature to approximately 250° C. Heat is transferred from a hot source, the oven, through convection. Alternatively, energy can be introduced through an electric potential, electromagnetic radiation, mechanical waves (ultrasound), or mechanically. The energy source is closely related to the duration, pressure, and energy per molecule that is introduced into a system, and each of these parameters can have a strong influence on the metal-organic framework formed and its morphology. A traditional synthesis is described by McDonald, T. M. et al. (2015) “Cooperative Insertion of CO₂ in Diamine Appended Metal-Organic Frameworks,” Nature, v.519, pp. 303-308, or Shearer, G. C. et al. (2016) “Defect Engineering: Tuning the Porosity and Composition of the Metal-Organic Framework UiO-66 via Modulated Synthesis,” Chem. Matter., v.28, pp. 3749-3761, incorporated herein by reference. Additional synthesis of making metal-organic frameworks is further described by McDonald, T. M., et al. (2012) “Capture of Carbon Dioxide from Air and Flue Gas in the Alkylamine-Appended Metal-Organic Framework mmen-Mg₂(dobpdc),” J. Am. Chem. Soc., v.134, pp. 7056-7065; Shearer, G. C. et al. (2014) “Tuned to Perfection: Ironing Out the Defects in Metal-Organic Framework UiO-66,” Chem. Matter., v.26, pp. 4068-4071; Cavka, J. H. et al. (2008) “A New Zirconium Inorganic Building Brick Forming Metal Organic Frameworks with Exceptional Stability” J. Am. Chem. Soc., v.130, pp. 113850-13851; Milner, P. J. et al. (2018) “Overcoming Double-step CO₂ Adsorption and Minimizing Water Co-Adsorption in Bulky Diamine-Appended Variants of Mg₂(dobpdc),” Chem. Sci., v.9, pp. 160-174; in U.S. Pat. No. 8,653,292, and in US Patent Publication Nos. 2007/0202038, 2010/0307336, and 2016/0031920.

### Synthesis of Metal-Organic Frameworks Using a Pre-Ligand

Provided herein are methods of making a metal-organic framework comprising: (a) combining a pre-ligand with a metal source comprising a metal component to provide a plurality of solid reactants; (b) adding a solvent to the plurality of solid reactants to form a reaction mixture, wherein at least 50 wt % of the reaction mixture are the plurality of solid reactants; (c) heating the reaction mixture wherein the pre-ligand is converted to a ligand in the reaction mixture and the ligand reacts with the metal component; and (d) cooling the reaction mixture to produce an insoluble portion and a soluble portion, wherein each of the steps (a) to (d) is performed without a formamide solvent, in particular wherein the reaction mixture is free of a formamide, such as free of dimethylformamide, and the insoluble portion comprises a plurality of the metal-organic frameworks, each metal-organic framework comprising the ligand and the metal component. The methods can further comprise the step of adding a crystallization aid to the reaction mixture with the solvent.

Also provided herein are methods of making a metal-organic framework comprising a plurality of tetravalent cations and a plurality of terephthalate linkers, comprising the steps of: (a) combining a pre-ligand selected from esters of a terephthalate with a metal source comprising a tetravalent metal component to provide a plurality of solid reactants; (b) adding a solvent comprising a monocarboxylic acid, and a crystallization aid comprising a divalent metal to the plurality of solids to form a reaction mixture having a mol ratio of monocarboxylic acid to ligand between 1:1 and 20:1; (c) heating the reaction mixture to a temperature to between about 100° C. and about 220° C.; (d) cooling the reaction mixture to produce an insoluble portion and a soluble portion; (e) separating the insoluble portion from the soluble portion; and (f) drying the insoluble portion to produce a plurality of the metal-organic frameworks. In the present methods, the metal source comprises a metal component. The insoluble portion comprises a plurality of the metal-organic frameworks. Each metal-organic framework comprises the ligand and the metal component. At least 50 wt % of the total weight percent of the reaction mixture is the plurality of solid reactants.

Each of the steps of the present methodologies (i.e., steps (a)-(d) and (a)-(f) respectively) are performed without a formamide solvent, in particular without dimethylformamide. More particularly, the reaction mixtures used in the present methodologies are free of a formamide solvent, such as dimethylformamide.

The pre-ligand is a derivative or a precursor of a linker (or ligand), e.g., of a fumarate or terephthalate linker, that can undergo a reaction, such as a hydrolysis or oxidation to form said linker, e.g., fumaric acid, terephthalic acid or a derivative thereof. More specifically, the pre-ligand may be any 1,4-substituted benzene derivative comprising a group such as a cyano or an ester group that can undergo a hydrolysis reaction to yield terephthalic acid, a deprotonated form of terephthalic acid, or a functionalized derivative thereof. More specifically the pre-ligand may be a terephthalate ester or a derivative thereof, such as polyethylene terephthalate, dimethyl terephthalate, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, and/or tetramethyl 1,2,4,5-benzene tetracarboxylate. In addition or in the alternative, the pre-ligand may be a fumarate ester, such as dimethylfumarate.

The metal source comprises a metal component. The metal component can be a tetravalent metal such as zirconium, cerium, hafnium and titanium, or a mixture thereof, preferably Zr or Zr/Hf Preferably, the metal source can generate the metal component, in particular as a tetravalent cation, in solution. Suitable examples of metal sources include metal oxide, chloride, nitrate or sulfate salt, a hydrate thereof, or an oxyanion salt thereof, such as, but not limited to, zirconium tetrachloride, zirconyl chloride, zirconyl nitrate, zirconyl sulfate, cerium ammonium nitrate, cerium nitrate, titanium tetrachloride, titanium oxysulfate, hafnium tetrachloride, hafnium oxychloride, hafnium oxynitrate, or hafnium oxysulfate. In an aspect, the tetravalent cation to ligand mol ratio may be between about 1.75:1 and about 1:1.75.

Solvents used in connection with the present methods are any components present in liquid form in the reaction mixture (e.g., at room temperature under normal pressure). In the present methods, the solvent typically includes at least one of a monocarboxylic acid and/or a mineral acid, in particular at least a monocarboxylic acid, and optionally water. Suitable examples of monocarboxylic acids include acetic acid (e.g., glacial acetic acid) and analogues thereof, such as formic acid, propionic acid, and mixtures thereof. Suitable examples of mineral acids include hydrochloric acid and analogues thereof, such as hydrobromic acid.

Solvent can be added to the reaction mixture in an amount between about 0.1 and about 1.0 weight equivalents relative to the solid reactants. For example, solvent is added to the reaction mixture in weight equivalents relative to the solid reactants in an amount between about 0.1 and about 0.9, between 0.1 and 0.8, between 0.1 and 0.7, between 0.1 and 0.6, between 0.1 and 0.5, between 0.1 and 0.4, between 0.1 and 0.3, or between 0.1 and 0.2.

When the solvent comprises a monocarboxylic acid, the mol ratio of monocarboxylic acid to ligand in the reaction mixture is preferably from 1: to 20:1, in particular from 1:1 to less than 20:1. In this embodiment, the expression “amount of ligand” corresponds to the amount of ligand resulting from the conversion of the pre-ligand during the heating step, e.g., the amount of fumaric acid or terephthalic acid (or deprotonated form or functionalized derivative thereof) resulting from the hydrolysis of corresponding fumarate ester or terephthalate ester (or derivative thereof). More particularly, the amount of monocarboxylic acid (e.g., acetic acid) to ligand (expressed as mol ratio) may be equal to or less than about 20:1, 19:1, 18:1, 17:1, 16:1, 15:1, 14:1, 13:1, 12:1, 11:1, and equal to or more than about 1:1, 2:1, 3:1, 4:1, 5:1, 6:1, 7:1, 8:1, 9:1 or 10:1.

When the solvent comprises a mineral acid, in the alternative or in addition to a monocarboxylic acid, the mol ratio of mineral acid to ligand in the reaction mixture is preferably at most 5:1. More particularly, the amount of mineral acid (e.g., HCl) to ligand (expressed as mol ratio) may range from 1:10 to 5:1, or from 1:2 to 3:1, such as from 1:1 to 2:1.

The crystallization aid can be a divalent metal, in particular a divalent metal selected from the group consisting of zinc, cobalt, tin, copper, and combinations thereof, e.g., zinc. Preferably, the divalent metal source can generate the divalent metal, in particular as a divalent cation, in solution. Suitable sources of divalent metal include divalent metal oxide, chloride, bromide, acetate, formate, oxylate, nitrate, sulfate, and/or oxyanion salts thereof, e.g., divalent metal oxide. For instance, when the divalent metal is zinc, the divalent metal source can be selected from the group consisting of zinc oxide, zinc chloride, zinc oxychloride, zinc bromide, zinc acetate, zinc sulfate, zinc nitrate, zinc oxynitrate, zinc oxylate, zinc formate, and mixtures thereof, e.g., zinc oxide. In an aspect, the divalent cation to tetravalent cation mol ratio may be from about 0 to about 5, for instance up to 2 or up to 1, such as up to 0.5, and/or at least 0.05, or at least 0.1, such as at least 0.15.

In the heating step, the reaction mixture is heated at a temperature and for a time sufficient to convert the pre-ligand into a ligand and for said ligand to react with the metal component. The heating step can include heating the sealed reaction mixture in static conditions for at least 4 to 6 hours. The heating step can also include heating the sealed reaction mixture under dynamic (e.g., stirred, shaken, mixed, agitated) conditions for, e.g., up to about 24 hours. The heating step can include heating the sealed reaction mixture in a static or rotating oven between about 70° C. to about 180° C. Heating can also be performed without sealing, with the MOF synthesized with the solvent(s) at reflux under approximately 1 bar of pressure. In an aspect, the reaction mixture is generally heated to 70° C. to 220° C., 100° C. to 220° C., about 70° C. to about 160° C., 100° C. to 160° C., 140° C. to 160° C., about 70° C., about 100° C., about 130° C., about 150° C., or about 160° C. for at least 4 hours to 7 days, or 6 hours to 5 days, or 12 hours to 3 days.

After cooling to e.g. room temperature, an insoluble portion and a soluble portion are produced, the insoluble portion comprising a plurality of the metal-organic frameworks. The present methods may further comprise separating the insoluble portion from the soluble portion and drying the insoluble portion to produce a plurality of the metal-organic frameworks. This can be done by any standard mean. For instance, the reaction mixture can be centrifuged or filtered to obtain the metal-organic frameworks.

The present methods may further comprise washing the metal-organic framework material separated from the reaction mixture by any standard means, for instance, the metal-organic framework material may be washed by a solvent such as DMF, methanol, ethanol, acetone and/or water, e.g., to remove excess organic ligand. The metal-organic framework material may also be washed in slightly basic solutions, for instance borate or formate solutions, such as boron borate or boron formate, to remove pendant ligands.

The present methods are especially suitable for the preparation of zirconium-based, titanium-based, cerium-based and/or hafnium-based metal-organic frameworks, in particular, Zr-based (or Zr/Hf-based) metal-organic frameworks, more particularly Zr— (or Zr/Hf—) metal-organic frameworks constructed from polytopic carboxylates, even more particularly Zr— (or Zr/Hf—) terephthalate metal-organic frameworks and/or Zr— (or Zr/Hf—) fumarate metal-organic frameworks. For instance, the present methods may be used for the preparation of metal-organic frameworks selected from the group consisting of UiO-66, EMM-71, Zr-Fumarate, UiO-67, MOF-808, NU-1000, or a functionalized derivative thereof.

The present methods are advantageous as they reduce the cost and labor required in order to obtain high quality MOFs. Since the methods require less time and more material can be synthesized, they also provide more material available for testing and characterization and reduce the amount of time significantly, which can have a significant economic impact.

It is integral that the quality of MOF is not sacrificed through the scale up process. Several characterization techniques, described in detail below, show that the novel methods disclosed herein produce similar or superior quality MOFs when compared to traditional synthesis.

### Synthesis and Characterization of EMM-32

Further, described herein are methods of manufacture of EMM-32, a metal-organic framework that exhibits challenging scale-up characteristics. First disclosed in Marshall, R. J. et al. “Postsynthetic bromination of UiO-66 analogues: altering linker flexibility and mechanical compliance”, Dalton Trans., v.45, 2016, pp. 4132-4135, EMM-32 was discovered as an advanced adsorbent for natural gas but has since been discovered to exhibit advantaged adsorption properties for the separation of lube-range molecules.

EMM-32 was synthesized by reacting the commercially available 4,4′-stilbenedicarboxylic acid (“SDC”) and zirconyl dichloride solvo-thermally in dimethylformamide using acetic acid (HOAc) as a reaction modulator. During the course of synthesis optimization, we discovered that not only was EMM-32 highly sensitive to reaction conditions, but also work-up and activation.

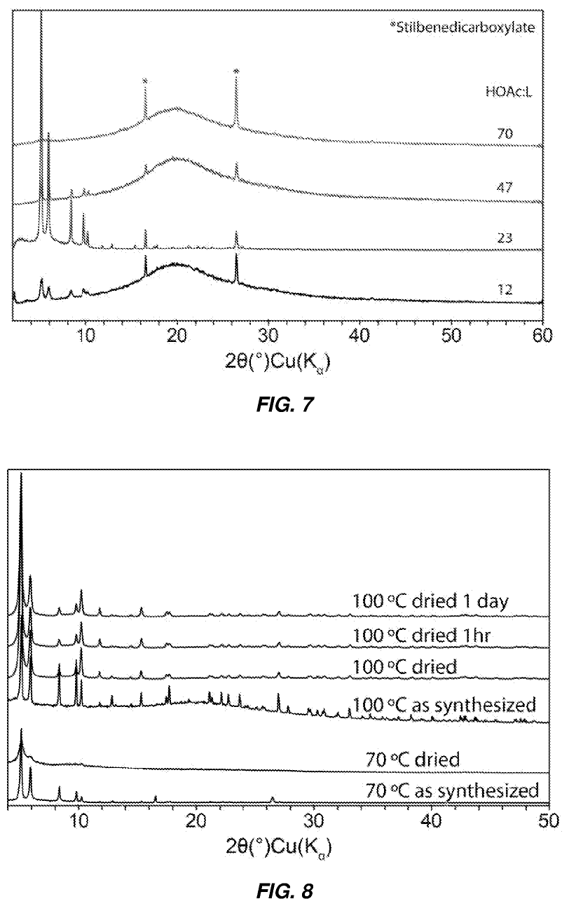

FIG. 7 shows the X-ray diffraction patterns of an EMM-32 synthesis using small difference in modulator (HOAc) concentration. We found that in a 70° C. synthesis, a HOAc:L mol ratio of approximately 20:1 is optimal for producing the highest crystallinity. Indeed, any ratio below or above this produced only small amounts of crystalline EMM-32 with a large amount of amorphous material. This ratio increased as a function of temperature and was optimal at approximately 40 to 1 (40:1) at 100° C. Like at 70° C., this optimal ratio of modulator to ligand exists in a very tight window, with which amorphous material exists outside.

However, we also found that increasing the temperature of the reaction was essential in creating materials stable towards activation. FIG. 8 shows powder X-ray diffraction patterns of EMM-32 synthesized at 70° C. and 100° C. both as synthesized and after solvent exchange and air drying. The as-synthesized sample is still immersed in protective solvent, owing to the large background observed. Materials grown under optimal conditions at 70° C. quickly lost much of their order upon solvent exchange and air drying. EMM-32 was also synthesized at 100° C. Contrary to the EMM-32 material synthesized at 70° C., the EMM-32 material synthesized at 100° C. kept its crystallinity upon solvent exchange and air drying, even after 1 day. The synthesis conducted at 100° C. maintained crystallinity after activation and maintained much of this crystallinity after a 24 hours exposure to atmospheric moisture.

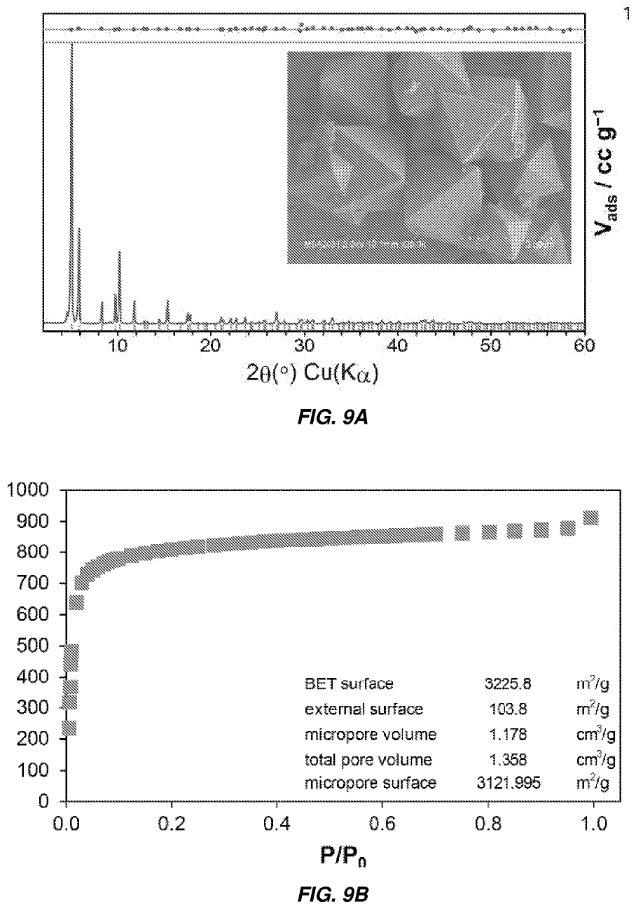

In addition to synthetic conditions, the method of isolation was found to be crucial in obtaining samples of both high crystallinity as well as high surface area. Samples filtered and washed with low-boiling solvents such as acetone typically lose their crystallinity, ostensibly due to the rapid evaporation of solvent from the pore structure. FIG. 9A shows powder X-ray diffraction pattern of EMM-32 after freeze drying and activation at 150° C. under vacuum. FIG. 9B shows a nitrogen adsorption isotherm for EMM-32 after benzene freeze drying and activation at 150° C. under dynamic vacuum for 12 hours. Predicted diffraction peaks as shown for the indexed unit cell of EMM-32. Non-indexed peaks all correlate to Cu KO peaks.

Empirically, we observed that solvent exchange with moderately volatile solvents such as acetonitrile followed by air drying, result in reasonably crystalline materials. However, these materials must be kept under dry conditions and, ideally, in a nitrogen glove box. For unit cell determination as well as gas adsorption studies, we performed an additional solvent exchange with benzene which was then removed by freeze drying. The sample was then heated to 150° C. under vacuum for 12 hours to obtain pristine EMM-32.

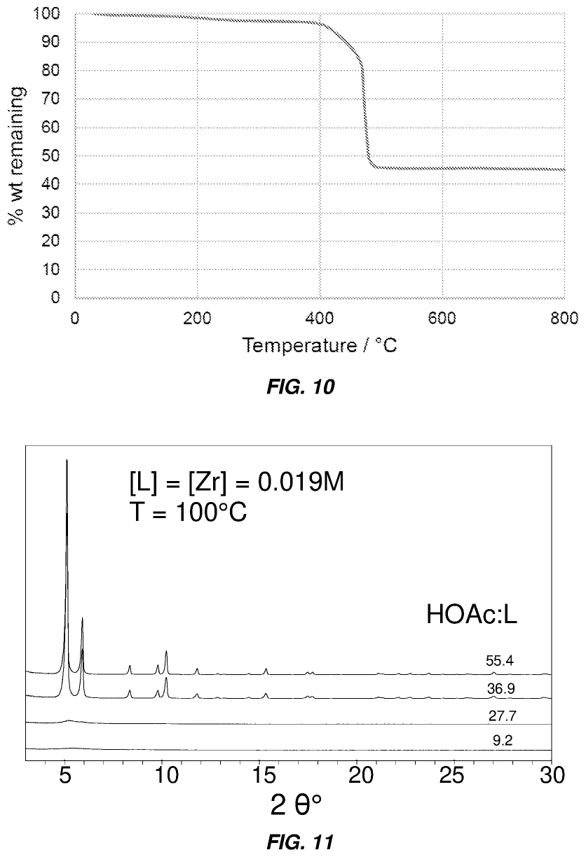

EMM-32 crystalizes in the cubic F432 space group with a unit cell dimension of 30.060 Å as determined by powder X-ray diffraction and adopts the octahedral crystal habitat typical of materials in the UiO-66 family of materials. FIG. 9A symmetry is identical to those reported for the isostructural the analogues, UiO-66 and UiO-67, as well as identical materials discovered concomitantly in the external literature. See e.g., Cavka, J. H. et al. (2008) “A New Zirconium Inorganic Building Brick Forming Metal Organic Frameworks with Exceptional Stability,” J. Am. Chem. Soc., v.130(42), pp. 13850-13851; Marshall, R. J. et al. (2016) “Postsynthetic Modification of Zirconium Metal-Organic Frameworks,” Eur. J. Inorg. Chem. pp. 4310-4331. This is nearly identical to the unit cell dimensions predicted from the AuToGraFS based generated and UFF4MOF optimized structure (30.2 Å). FIG. 9B depict the nitrogen adsorption isotherm conducted at 77K on optimally synthesized and activated EMM-32. Micropore BET surface area of 3122 m²/g were observed with micropore volumes of 1.178 cc/g. This is in agreement with the pore volumes predicted from the high-throughput simulation system employed. Discrepancies between predicted and realized pore volumes appear to be due to intrinsic inaccuracies of the pore volume prediction as well as material imperfections and defect in the material. Zirconium-based UiO-type materials are known to poses both missing-linker and missing-node defects which are highly dependent on synthesis conditions. See e.g., Shearer, G. C. et al. (2014) “Tuning to Perfection: Ironing Out the Defects in Metal-Organic Framework UiO-66,” Chemistry of Materials, 14, v.26, pp. 4068-4071; Wu, H. et al. (2013) “Unusual and Highly Tunable Missing-Linker Defects in Zirconium Metal-Organic Framework UiO-66 and Their Important Effects on Gas Adsorption,” J. Am. Chem. Soc. 135, v.28, pp. 10525-10532; Gutov, O., et al. (2015) “Metal-Organic Framework (MOF) Defects Under Control: Insights into the Missing Linker Sites and Their Implication in the Reactivity of Zirconium Based Frameworks,” Inorg. Chem. v.54(17), pg. 8396. Thermogravimetric analysis (TGA) indicates that these defects are indeed prevalent with approximately 40 percent (40%) of the linkers missing from the structure as evidence by TGA. FIG. 10 is a thermo gravimetric analysis (TGA) curve of EMM-32 showing decomposition at approximately 400° C. The remaining ZrO₂ content as well as relative amount of organic mass loss, indicates the degree of defect in the structure.

### Development of the Present Methodologies

Under standard conditions of a modulator to ligand mol ratio greater than 20, EMM-32 shows either low crystallinity or has different crystal phases. In an embodiment, we have discovered that synthesizing EMM-32 in unique synthesis regimes can lead to crystalline samples at concentrations 5 to 10 times of that used in traditional syntheses. However, beyond concentrations of 0.17 mol 4,4′-stilbenedicarboxylic acid (“SDC”) per liter of solvent, even optimal conditions can yield crystalline materials suitable for scale-up.

To achieve higher percent solid of reactants in a reaction mixture, an amount of a crystallization aid in the reaction mixture provides materials having high crystallinity and good phase selectivity. In an embodiment, we found that zinc compounds can act to effectively promote the crystallization of metal-organic frameworks including EMM-32 to allow for successful syntheses at concentrations up to (and possibly beyond) 0.52 mol/l.

As shown in Table 1 immediately below, previously EMM-32 was synthesized under dilute conditions where a ligand concentration was below 0.06 mol/l. This concentration equates to 16 grams per liter of solvent or 1.6% solid reactants (or 3% if ZrCl₄ were added). Acetic acid, benzoic acid, or hydrochloric acid was used as a modulator (Mod.). If acetic acid was used in the literature, the volume of acetic acid is represented in the “Acetic Acid” column. If hydrochloric acid or benzoic acid were used, the mol ratio of modulator to ligand is represented in the ‘Mod.:L’ column. The identity of the modulator used is indicated by the superscript number in the ‘Mod.:L’ column.

TABLE 1

| | | | ZrOCl₂ | | Acetic | | | | | |
|---|---|---|---|---|---|---|---|---|---|---|
| | SDC | ZrCl₄ | 8H₂O | DMF | Acid | | Mod.: | T | | Time |
| Ref | (mg) | (mg) | (mg) | (mL) | (mL) | [L] | L | (° C.) | [Zr] | (D) |
| 1 | 68.4 | 60 | — | 4 | 0.6 | 0.055 | 40.5⁽¹⁾ | 120 | 0.056 | 2 |
| 2 | 120 | 105 | — | 15 | 0 | 0.030 | 0⁽³⁾ | 120 | 0.030 | 3 |
| 3 | 27 | 24 | — | 5 | 0 | 0.020 | 30.7⁽²⁾ | 130 | 0.021 | 3 |
| 4 | 9 | 34 | — | 2 | 0.175 | 0.015 | 89.7⁽¹⁾ | 115 | 0.067 | 2 |
| 5 | 120 | 104 | — | 18 | 3.3 | 0.021 | 127⁽¹⁾ | 100 | 0.021 | 3 |
| 6 | 27 | 24 | — | 5 | 0 | 0.020 | 30.7⁽²⁾ | 130 | 0.021 | 3 |
| 7 | 101 | 101 | — | 8.5 | 0 | 0.044 | 22.4⁽²⁾ | 120 | 0.051 | 4 |
| Inv. | 1000 | — | 1200 | 10 | 0.75 | 0.347 | 3.46⁽¹⁾ | 100 | 0.35 | 1 |
| 8 | | | | | | | | | | |
| Inv. | 1500 | — | 1800 | 10 | 0.35 | 0.541 | 1.08⁽¹⁾ | 120 | 0.54 | 1 |
| 9 | | | | | | | | | | |

⁽¹⁾Acetic acid,
⁽²⁾benzoic acid,
⁽³⁾HCl.

With respect to Table 1, “D” represents the number of days, “[L]” represents the ligand concentration as moles of ligand (SDC) per liter of solvent (DMF+acetic acid+optional water), “[Zr]” represents the zirconium concentration as moles of Zr per liter of solvent (DMF+acetic acid+optional water), and “Mod:L” represents the mol ratio of modulator (acetic acid or benzoic acid) per ligand (SDC).

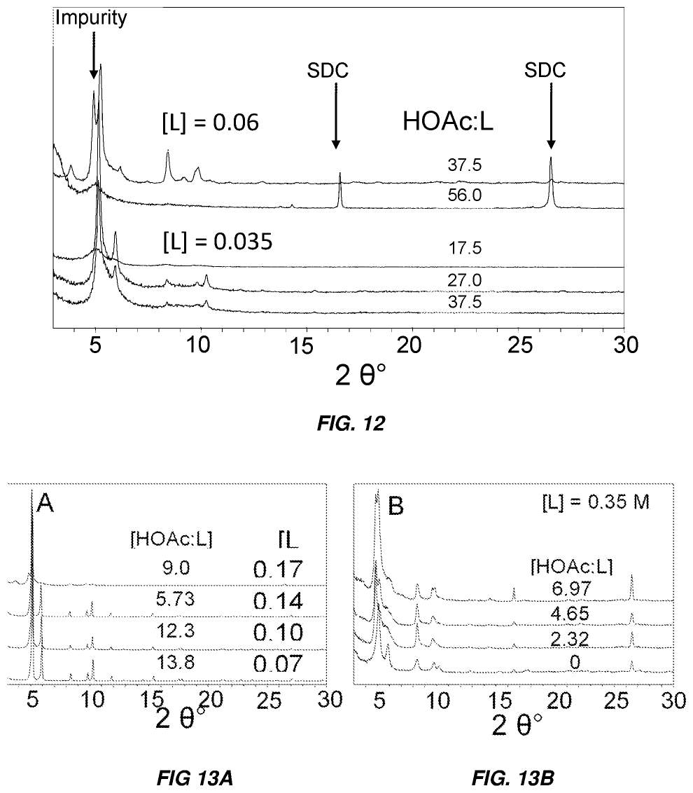

In examining the synthesis, we found that the amounts of solid reactants were unacceptably low and would result in little space time yield in fixed batch reactors with increased solvent costs. As described herein, we found that reactions at higher concentrations would only work to a point. For example, when an initial synthesis was operated at a SDC and Zr concentration of 0.019 mol/l, crystalline samples were only obtained with sufficiently high modulator to ligand mol ratios (i.e., 55 and 36 vs. 27 and 9). See FIG. 11. But, when similar conditions were used with SDC concentration of 0.035 mol/l or 0.06 mol/l and modulator to ligand mol ratios from 17.5 to 56, we found that the materials obtained were only partially crystalline. See FIG. 12.

When the synthesis was performed with a limited HOAc:L (acetic acid to ligand mol ratio from 5.73 to 13.8), a crystalline sample could be obtained with ligand (SDC) concentrations as high as 0.14 mol/l. FIG. 13A shows the powder X-ray diffraction patterns of EMM-32 samples synthesized at ligand concentrations ranging from 0.07 mol/l to 0.17 mol/l using optimized acetic acid to ligand mol ratio. A low signal intensity was obtained for samples made from 0.17 mol/l conditions. However, beyond this ratio, only partially crystalline materials are obtained.

Typically, crystallinity is improved by increasing modulator concentration. When using high concentrations of reactants, however, impurities can form. FIG. 13B shows the powder X-ray diffraction patterns for EMM-32 synthesized at ligand (SDC) concentrations of 0.35 mol/l. As shown in FIG. 13B, the materials formed were poorly crystalline. Only at zero acetic acid was a semicrystalline EMM-32 sample observed. Beyond that, an impurity phase was predominant. Additional modulator did not improve the crystallinity of these materials.

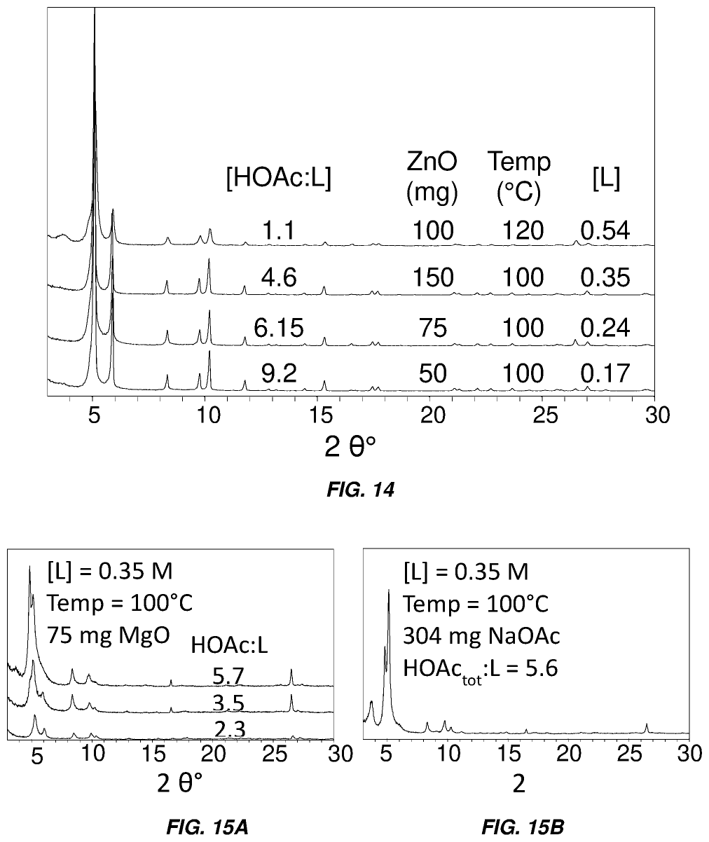

With this data in hand, we understood that while unique reaction conditions can provide avenues to achieve reaction concentrations as high at 0.14 mol/l, a method of aiding the crystallization was needed to obtain even higher concentrations. Surprisingly, zinc oxide (which is not expected to interact or incorporate in the framework) effectively aided the crystallizations allowing for at least doubling the reaction concentration. For example, FIG. 14 shows the powder X-ray diffraction patterns of EMM-32 samples synthesized with ligand concentrations ranging from 0.17 to 0.54 mol/l and using zinc oxide as a crystallization aid. All reactions were conducted on 10 mL scales (with respect to DMF). The amount of acetic acid in each sample was optimized independently. To these reactions, we added differing amounts of zinc oxide and found that crystalline samples could be obtained. Like in our non-metal-mediated syntheses, ideal acetic acid to ligand mol ratios were low compared to the prior art and fell to lower values as concentrations increased.

Surprised by this result, we tried to decouple the effects of the presence of zinc cations that are formed from the reaction of ZnO with SDC and acetic acid during the reaction. To test this, we screened the effect of magnesium oxide in the synthesis of EMM-32. As shown in FIG. 15A, when we attempted the same 0.35 mol/l reaction that was successful with ZnO with an equal molar amount of magnesium oxide, we obtained a poorly crystalline sample. Similarly, if acetate equivalents were added (assumed to be generated from the reaction of ZnO with acetic acid), poor quality materials were observed. See FIG. 15B.

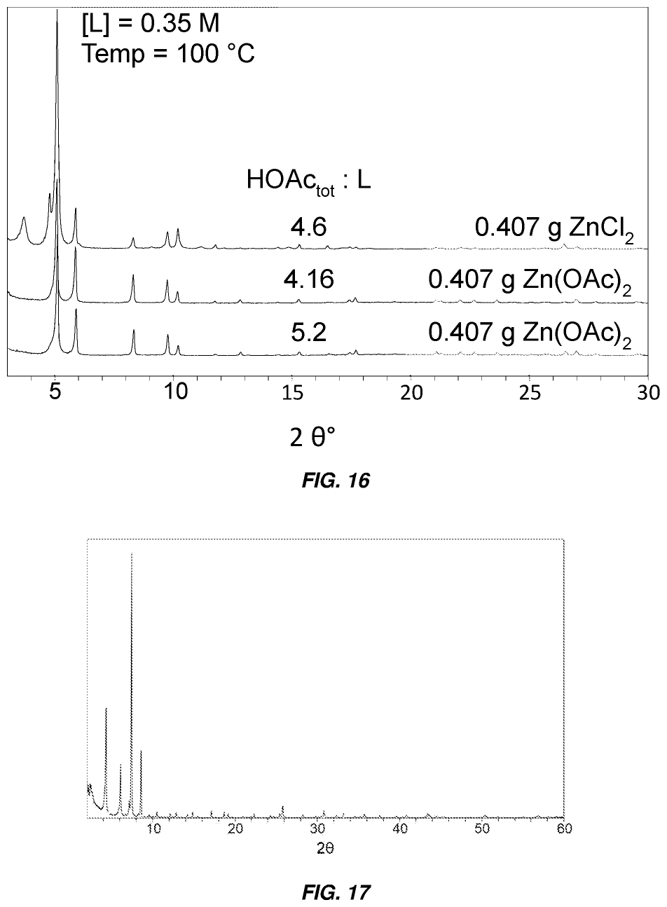

The inability of simple basic oxides and salts such as magnesium oxide and sodium acetate to aid in the crystallization of EMM-32 lead us to believe that the zinc cation itself plays a role in crystallization mediation. To test this, we used zinc acetate or zinc chloride as mediators. As seen in FIG. 16, the addition of zinc acetate appeared to be equally effective in aiding the crystallization of EMM-32. Materials made in the presence of zinc chloride also showed remarkably higher crystallinity compared to samples made without the presence of the salt. Further, material made by the present methods does not show the same amounts of sensitivities observed when the material was originally made, even without any special activations. The metal-organic frameworks were found to be stable and did not degrade over time.

Aspects of the disclosure are described in greater detail by way of specific examples. The following examples are offered for illustrative purposes, and are not intended to limit the disclosure in any manner. Those of skill in the relevant art will readily recognize a variety of parameters can be changed or modified to yield essentially the same results.

### EXAMPLES

The features of the disclosure are described in the following non-limiting examples.

In these examples, the X-ray diffraction (XRD) patterns of the materials were recorded on either a Panalytical XPert Pro powder X-ray diffractometer fitted with an Anton Paar HTK-16N environmental stage equipped with a Pt-strip heater, or a Bruker D8 Envdevor instrument in continuous mode using a Cu Kα radiation, Bragg-Bentano geometry with Lynxeye detector, in the 20 range of 2 to 60°. In both cases, the interplanar spacings, d-spacings, were calculated in Angstrom units. The intensities are uncorrected for Lorentz and polarization effects. The location of the diffraction peaks in 2-theta, and the relative peak area intensities of the lines, I/I(o), where Io is the intensity of the strongest line, above background, were determined with the MDI Jade peak fitting algorithm using a 3rd order polynomial background fit. It should be understood that diffraction data listed as single lines may consist of multiple overlapping lines which under certain conditions, such as differences in crystallographic changes, may appear as resolved or partially resolved lines. Typically, crystallographic changes can include minor changes in unit cell parameters and/or a change in crystal symmetry, without a change in the framework connectivity. These minor effects, including changes in relative intensities, can also occur as a result of differences in cation content, framework composition, nature and degree of pore filling, crystal size and shape, preferred orientation and thermal and/or hydrothermal history. All samples were analyzed as is and without any further grinding.

The relative intensity is measured by the method of Shearer, G. C. et al., Defect Engineering: Tuning the Porosity and Composition of the Metal-Organic Framework UiO-66 via modulated Synthesis, Chem. Mater., v.28(11), pp. 3749-3761, 2016. Relative intensity is characteristic of the degree of defects, in particular of node defects, in the framework. As detailed in Shearer et al., relative intensity of the broad peak (i.e., between 3 and 7° 2θ) is a quantitative descriptor for the concentration of missing cluster defects in the framework, e.g., in the UiO-66 framework. Relative intensity is calculated as the integrated intensity of the broad peak (around 5° 2θ, such as between 2 and 7° 2θ, i.e., corresponding to the aggregate integrated intensity of the (100) and (110) peaks in the present invention) divided by the average of the intensity of the (111), (200), and (600) peaks which corresponds respectively to peaks at about 7.4, 8.5 and 25.8° 2θ.

$$Relative Intensity = \frac{I ( broad peak )}{[ ( I ( 111 ) + I ( 200 ) + I ( 600 ) ) / 3 ]}$$

The peak width ratio is the ratio between the calculated peak width at half maximum (as calculated by the MDI Jade peak fitting algorithm) of the (110) peak and the (111) peak occurring at ˜6 and 7.4° 2θ.

The scanning electron microscopy (SEM) images of the as-synthesized materials were obtained on a Hitachi 4800 Scanning Electron Microscope.

The overall surface area (BET Surface or S_{BET}) of the materials was determined by the BET method as described by S. Brunauer, P. H. Emmett and E. Teller, J. Am. Chem. Soc., 1938, v.60, pg. 309, incorporated herein by reference, using nitrogen adsorption-desorption at liquid nitrogen temperature. The external surface area (Sₑₓₜ) of the material was obtained from the t-plot method, and the micropore surface area (S_{micro}) of the material was calculated by subtracting the external surface area (Sₑₓₜ) from the overall BET surface area (S_{BET}).

The total pore volume and micropore volume of the materials can be determined using methods known in the relevant art. For example, the porosity of the materials can be measured with nitrogen physisorption, and the data can be analyzed by the t-plot method described in Lippens, B. C. et al., “Studies on pore system in catalysts: V. The t method”, J. Catal., v.4, pg. 319 (1965), which describes micropore volume method and is incorporated herein by reference.

Thermogravimetric analysis (TGA) was performed on the materials by heating in air from room temperature to 800° C.

High pressure CH₄ adsorption was measured using a Hidden Volumetric gas adsorption analyzer (Kortunov, et al., 2016).

### Example 1: Synthesis of UiO-66 for Naphthalene Separations (Comparative)

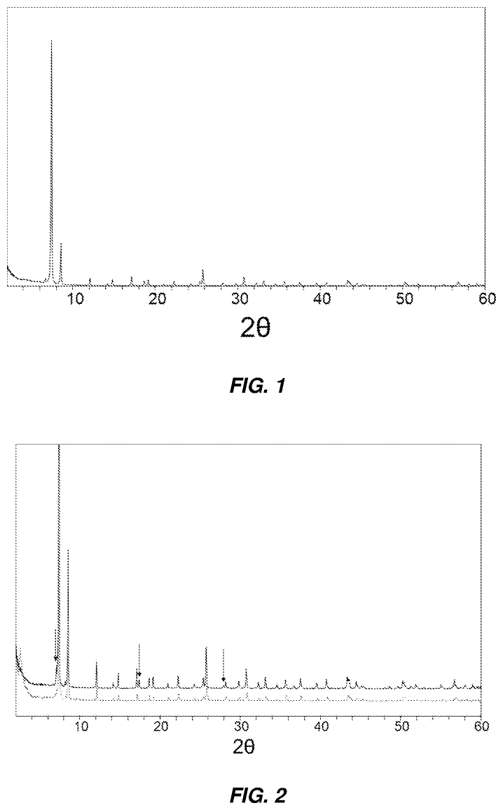

66.375 grams (400 millimole (“mmol”) of terephthalic acid and 92.25 grams (297 mmol) of zirconyl chloride octahydrate (ZrOCl₂·8H₂O) were loaded into a round bottom flask with 937 mL of dimethyl formamide (DMF) and 573 mL of glacial acetic acid (HOAc:L=24.21) and heated to 120° C. for 16 hours. The resulting product was centrifuged and washed three times (“3×”) with DMF (200 milliliters (“mL”) each) followed by two solvent washes with acetone (2×200 mL). The resulting acetone wet solid was allowed to air dry. FIG. 1 shows the X-ray diffraction pattern of a sample produced through this method.

### Example 2: Use of Dimethyl Terephthalate (“DMT”) to Form UiO-66 without Dimethylformamide (“DMF”)

25 grams of dimethyl terephthalate (“DMT”, 127 mmol) and 41.25 grams of zirconyl chloride octahydrate (ZrOCl₂·8H₂O, 128 mmol) were charged into a 125 mL Teflon lined parr reaction vessel. Zinc oxide was added (0-6 grams [0-74 mmol]) followed by 16-24 mL of acetic acid (mol ratio HOAc:DMT=2.15-3.30). The reaction mixture was manually mixed to homogenize the mixture and then sealed and heated to 140° C. to 160° C. for 16 hours and allowed to cool. The insoluble portion was then extracted from the reactor and suspended in 300 mL of water and heated at between room temperature and 100° C. for between 5 minutes and 240 minutes. Metal-organic frameworks were isolated and optionally washed with additional water. The metal-organic frameworks were then solvent exchanged with a low boiling solvent such as acetone. The metal-organic frameworks were air dried and optionally calcined to between 150° C. and 350° C.

As made and after water washing, several impurity peaks can be observed in the X-ray diffraction pattern (“PXRD”) of the metal-organic frameworks obtained (FIG. 2, upper curve). Impurities can be removed through calcination (FIG. 2, below curve).

As shown in FIG. 3, the gas adsorption of samples made by the present example (after water or formate washing followed by 250° C. calcination (darkest and medium gray curves respectively)) were compared to those samples made through the comparative method of Example 1 (light gray curve). In the samples prepared through Example 2 and at 0.0001 P/P₀, a more pronounced feature is observed followed by a more modest increase in adsorption in the pressure region of 0.001-1 P/P₀. This feature is indicative of a relatively low level of node and/or ligand defects.

### Example 3: Use of Post-Consumer Polymer as a Starting Material

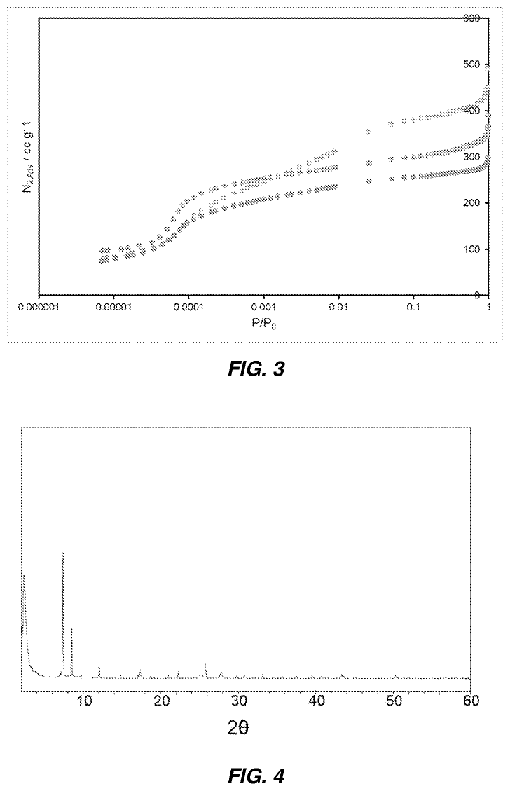

312 milligrams (“mg”) of polyethylene terephthalate (PET) plastic chips (1 centimeter squared (“cm²”)) were added with 298 mg of zirconium tetrachloride to a 23 mL parr reactor. 200 microliter (“uL”) of acetic acid was added and the reactor heated to 160° C. for 16 hours. The reactor was cooled and the solids were washed with water followed by acetone and then were air dried. As shown in FIG. 4, the resulting brown powder was analyzed by PXRD and found to be phase-pure UiO-66.

### Example 4: Use of DMT to Form UiO-66 without DMF or ZnO

Dimethyl terephthalate (“DMT”) and ZrOCl₂ hydrate were loaded into a 10 CC autoclave and acetic acid was added (0-500 uL). The reaction mixture was sealed and heated overnight at 150° C. After cooling to room temperature, the samples were analyzed by X-ray diffraction. As shown in FIG. 5, samples with less than 150 uL of acetic acid exhibited impurity peaks at 7° 2θ while samples with 150 uL of acetic acid or more showed the presence of contaminant peaks at 9.5° 2θ. These contaminants are soluble in water and can be removed upon further washing of the material with water but this results in a lower UiO-66 yield.

### Example 5: UiO-66 Produced without DMF and with DMT and ZnO

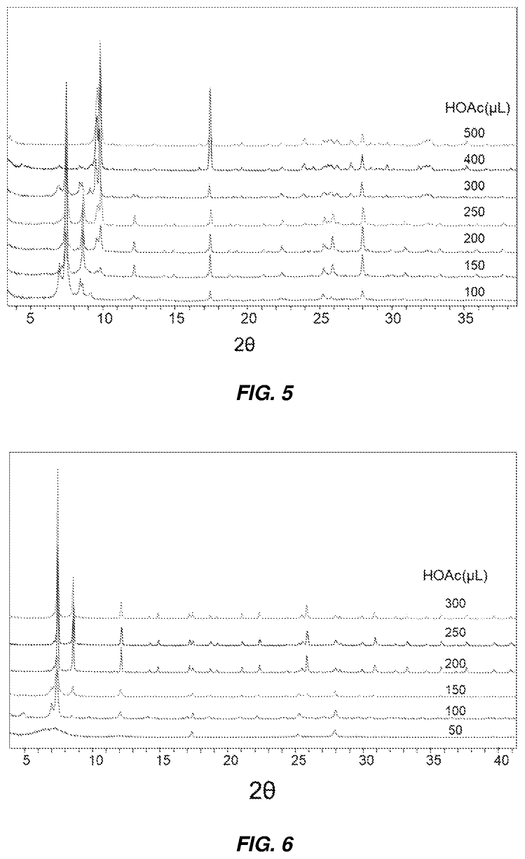

312 mg of dimethyl terephthalate (DMT), 414 mg of zirconyl chloride and 25-50 mg of zinc oxide was added to a 25 mL parr autoclave. 50-300 uL of acetic acid was added and the reactions heated to 150° C. for 12-15 hours. As compared to Example 4, the formation of the impurity at 9.5° 2θ is effectively suppressed by the presence of zinc oxide in the recipe at higher acetic acid concentrations (e.g., from 150 to 300 uL HOAc). See FIG. 6.

### Example 6: Synthesis of EMM-71 without DMF and with DMT and HCl

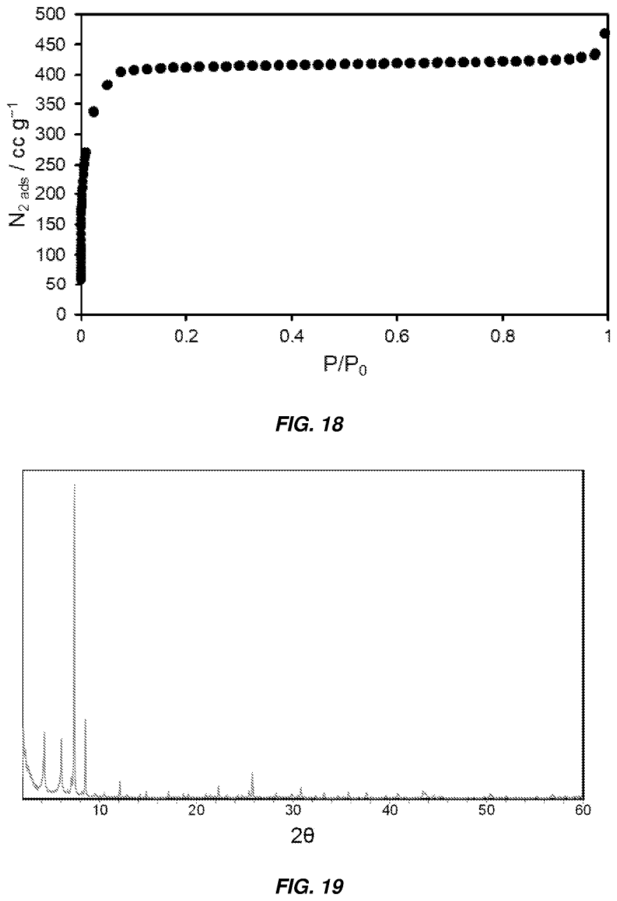

18 grams of dimethyl terephthalate was added along with 29.64 grams of zirconium oxychloride to a 125 mL autoclave. 14.4 mL of acetic acid and 8.64 mL of hydrochloric acid was added and the mixture mixed with a spatula. The autoclaves were sealed and heated to 150° C. over 0-8 hours then held at 150° C. for 5-10 hours. The autoclaves were then allowed to cool. Solids (the insoluble portion of the reaction mixture) were suspended in water and isolated via filtration. The insoluble portion was then washed with dimethylformamide at 70° C. and isolated again via filtration. These solids were then washed with 0.25 M aqueous sodium formate at 80° C. and isolated via filtration and the filter cake washed with water followed by acetone. FIG. 17 shows the PXRD pattern of the EMM-71 metal-organic framework produced. FIG. 18 shows the adsorption isotherm conducted at 77° K on EMM-71 as synthesized. The surface area was measured at 1700 m²/g.

### Example 7: Synthesis of EMM-71 without DMF and with DMT and HCl at Lower Temperature

25 grams of dimethyl terephthalate was added along with 41.17 grams of zirconium oxychloride to a 125 mL autoclave. 20 mL of acetic acid and 12 mL of hydrochloric acid was added and the mixture mixed with a spatula. The autoclaves were sealed and heated to 120° C. over 0-8 hours and held at 120° C. for 5-10 hours. This can optionally be done while tumbling in the oven. The autoclaves were heated to 14-18 hours then allowed to cool. Solids (the insoluble portion of the reaction mixture) were suspended in water and isolated via filtration. The insoluble portion was then washed with dimethylformamide at 70° C. and isolated again via filtration. These solids were then washed with 0.25 M aqueous sodium formate at 80° C. and isolated via filtration and the filter cake washed with water followed by acetone. FIG. 19 shows the powder X-ray diffraction pattern of EMM-71 synthesized as described in this example.

### Example 8: Synthesis of EMM-71 without DMF and with Functionalized NH₂-DMT and HCl (NH₂-EMM-71)

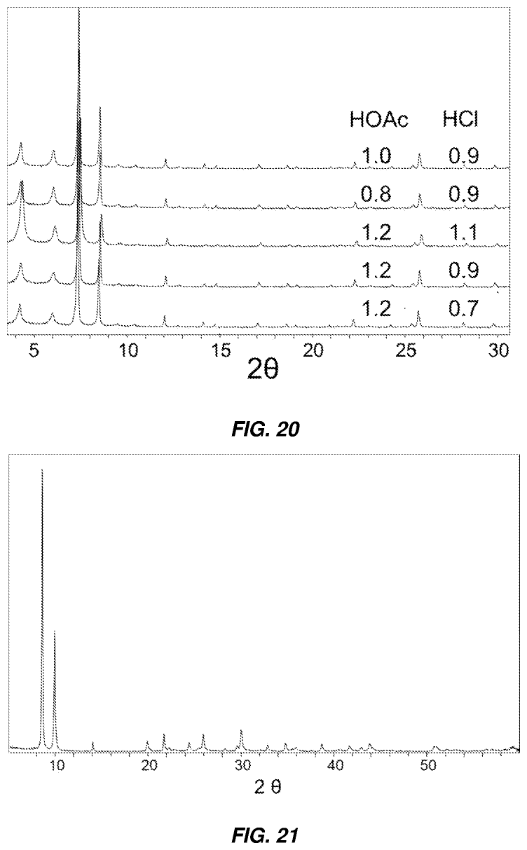

1.45 grams of dimethyl 2-aminoterephthalate, 2.635 grams of zirconium oxychloride and 0.84 grams of hafnium oxychloride were loaded into a 23 mL autoclave. 0.8-1.2 mL of acetic acid was added, as well as 0.7-1.1 mL of concentrated hydrochloric acid. The mixture was homogenized to form a paste and heated to 120-150° C. over 0-8 hours then held at 120-150° C. for 5-10 hours. The solids were then suspended in water and isolated via filtration or centrifugation. The solids were optionally washed with dimethylformamide and/or acetone. The solids were dried to yield yellow NH₂-EMM-71. The X-rays of samples made with different solvent conditions are displayed in FIG. 20. The sample in order from bottom to top have relative intensities of 0.88, 1.0, 2.5, 1.1, and 1.1 respectively. Their peak width ratios, in order from bottom to top, are 2.56, 3.02, 1.94, 2.17, and 2.47.

### Example 9: Synthesis of Zr-Fumarate without DMF and with Dimethylfumarate

3.5 grams of a solid mixture of dimethylfumarate, zirconium oxychloride, and hafnium oxychloride (wt ratio of dimethyl fumarate:ZrOCl₂·8H₂O:HfOCl₂·8H₂O=1:1.85:0.48) was added to a teflon-lined 23 mL autoclave. 0.5-1 mL of concentrated hydrochloric acid was added followed by 0.8-1.4 mL of acetic acid. The reaction was sealed and heated to 120-150° C. over 0-8 hours then held at temperature for 5-10 hours. The solids were then suspended in water and isolated via filtration or centrifugation. The solids were optionally washed with dimethylformamide and/or acetone. The solids were dried to yield white zirconium fumarate. The X-ray of a sample made through Example 9 is shown in FIG. 21. In this case, no defects are formed and no relative intensity and peak ratio values are calculated.

Additionally or alternately, the invention relates to:

Embodiment 1. A method of making a metal-organic framework comprising:
(a) combining a pre-ligand with a metal source comprising a metal component to provide a plurality of solid reactants;
(b) adding a solvent to the plurality of solid reactants to form a reaction mixture, wherein at least 50 wt % of the reaction mixture are the plurality of solid reactants;
(c) heating the reaction mixture wherein the pre-ligand is converted to a ligand in the reaction mixture and the ligand reacts with the metal component; and
(d) cooling the reaction mixture to produce an insoluble portion and a soluble portion,
wherein the reaction mixture does not comprise dimethylformamide and the insoluble portion comprises a plurality of the metal-organic frameworks, each metal-organic framework comprising the ligand and the metal component.

Embodiment 2. The method of embodiment 1, wherein the pre-ligand is a fumarate ester or a terephthalate ester.

Embodiment 3. The method of embodiment 2, wherein the pre-ligand is selected from the group consisting of dimethylfumarate, dimethyl terephthalate, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof, preferably from dimethylfumarate, dimethyl terephthalate, dimethyl 2-aminoterephthalate, and/or polyethylene terephthalate.

Embodiment 4. The method of any one of embodiments 1 to 3, wherein the metal component is a tetravalent metal selected from the group consisting of zirconium, titanium, cerium, hafnium, and combinations thereof, preferably from zirconium or a mixture of zirconium and hafnium, more preferably zirconium.

Embodiment 5. The method of any one of embodiments 1 to 3, wherein the metal organic framework is a zirconium-based metal organic framework or a zirconium-based metal organic framework further comprising hafnium, preferably a zirconium-based metal organic framework.

Embodiment 6. The method of any one of embodiments 1 to 5, wherein the solvent comprises at least one of a monocarboxylic acid and/or a mineral acid, and optionally water, preferably wherein the solvent comprises at least a monocarboxylic acid.

Embodiment 7. The method of embodiment 6, wherein the monocarboxylic acid is selected from the group consisting of acetic acid, formic acid, propionic acid, and mixtures thereof, preferably acetic acid, more preferably glacial acetic acid.

Embodiment 8. The method of embodiment 6 or 7, wherein the mineral acid is selected from the group consisting of hydrochloric acid, hydrobromic acid, and mixtures thereof, preferably hydrochloric acid.

Embodiment 9. The method of any one of embodiments 6 to 8, wherein the amount of monocarboxylic acid, in particular of acetic acid, to ligand in the reaction mixture is from 1:1 to 20:1, as mol ratio.

Embodiment 10. The method of any one of embodiments 6 to 9, wherein the amount of mineral acid, in particular of HCl, to ligand in the reaction mixture is of at most 5:1, as mol ratio.

Embodiment 11. The method of any one of embodiments 1 to 10, wherein the solvent is added to the reaction mixture in an amount between 0.1 and 1.0 weight equivalents relative to the solid reactants.

Embodiment 12. The method of any one of embodiments 1 to 11, further comprising adding a crystallization aid to the reaction mixture with the solvent.

Embodiment 13. The method of embodiment 12, wherein the crystallization aid is a divalent metal selected from the group consisting of zinc, cobalt, tin, copper, and combinations thereof, preferably zinc.

Embodiment 14. The method of embodiment 13, wherein the divalent metal source is a divalent metal oxide, chloride, bromide, acetate, formate, oxylate, nitrate, sulfate, and/or oxyanion salts thereof, preferably a divalent metal oxide, more particularly zinc oxide.

Embodiment 15. The method of any one of embodiments 1 to 14, wherein the reaction mixture is heated to a temperature of between about 100° C. and 220° C.

Embodiment 16. The method of any one of embodiments 1 to 15, wherein the metal organic framework is a Zr-terephthalate metal-organic framework or a Zr-fumarate metal-organic framework.

Embodiment 17. The method of any one of embodiments 1 to 16, wherein the metal-organic framework is selected from UiO-66, EMM-71, zirconium fumarate, MOF-808, NU-1000, or a functionalized derivative thereof, preferably from UiO-66, EMM-71, and zirconium fumarate.

Embodiment 18. The method of any one of embodiments 1 to 17, further comprising: separating the insoluble portion from the soluble portion; and/or drying the insoluble portion to produce a plurality of the metal-organic frameworks.

Embodiment 19. A method of making a metal-organic framework comprising a plurality of tetravalent cations and a plurality of terephthalate linkers, comprising:
(a) combining a pre-ligand selected from esters of a terephthalate with a metal source comprising a tetravalent metal component to provide a plurality of solid reactants;
(b) adding a solvent comprising a monocarboxylic acid and a crystallization aid comprising a divalent metal to the plurality of solids to form a reaction mixture having a mol ratio of monocarboxylic acid to ligand between 1:1 and 20:1, wherein at least 50 wt % of the reaction mixture are the plurality of solid reactants;
(c) heating the reaction mixture to a temperature of between about 100° C. and about 220° C.;
(d) cooling the reaction mixture to produce an insoluble portion and a soluble portion, wherein the insoluble portion comprises a plurality of the metal-organic frameworks, each metal-organic framework comprising the ligand and the metal component;
(e) separating the insoluble portion from the soluble portion; and
(f) drying the insoluble portion to produce a plurality of the metal-organic frameworks, wherein the reaction mixture does not comprise dimethylformamide.

Embodiment 20. The method of embodiment 19, wherein the pre-ligand is selected from the group consisting of dimethyl terephthalate, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof, preferably from dimethyl terephthalate, dimethyl 2-aminoterephthalate, and/or polyethylene terephthalate.

Embodiment 21. The method of embodiment 19 or 20, wherein the tetravalent metal component is selected from the group consisting of zirconium, hafnium, and combinations thereof.

Embodiment 22. The method of any one of embodiments 19 to 21, wherein the monocarboxylic acid is selected from the group consisting of acetic acid, formic acid, propionic acid, and mixtures thereof, preferably acetic acid, more preferably glacial acetic acid.

Embodiment 23. The method of any one of embodiments 19 to 22, wherein the crystallization aid is zinc oxide.

Embodiment 24. The method of any one of embodiments 19 to 23, wherein the reaction mixture is heated to a temperature of between about 100° C. and 220° C.

Embodiment 25. The method of any one of embodiments 19 to 24, wherein the metal-organic framework is selected from UiO-66, EMM-71, zirconium fumarate, MOF-808, NU-1000, or a functionalized derivative thereof, preferably from UiO-66, EMM-71, and zirconium fumarate.

Many alterations, modifications, and variations will be apparent to those skilled in the art in light of the foregoing description without departing from the spirit or scope of the present disclosure and that when numerical lower limits and numerical upper limits are listed herein, ranges from any lower limit to any upper limit are contemplated.

1-20. (canceled)

21. A method of making a metal-organic framework comprising:
combining a pre-ligand with a metal source comprising a metal component to provide a plurality of solid reactants;
adding a solvent to the plurality of solid reactants to form a reaction mixture, wherein at least 50 wt % of the reaction mixture are the plurality of solid reactants;
heating the reaction mixture wherein the pre-ligand is converted to a ligand in the reaction mixture and the ligand reacts with the metal component; and
cooling the reaction mixture to produce an insoluble portion and a soluble portion, wherein the reaction mixture does not comprise dimethylformamide and the insoluble portion comprises a plurality of the metal-organic frameworks, each metal-organic framework comprising the ligand and the metal component.

22. The method of claim 21, wherein the pre-ligand is a fumarate ester or a terephthalate ester.

23. The method of claim 22, wherein the pre-ligand is selected from the group consisting of dimethylfumarate, dimethyl terephthalate, dimethyl 2-aminoterephthalate, dimethyl 2-nitroterephthalate, dimethyl 2-chloroterephthalate, dimethyl 2-bromoterephthalate, trimethyl 1,2,4-benzene tricarboxylate, trimethyl 1,3,5-benzene tricarboxylate, tetramethyl 1,2,4,5-benzene tetracarboxylate, polyethylene terephthalate, and mixtures thereof.

24. The method of claim 21, wherein the metal component is a tetravalent metal selected from the group consisting of zirconium, titanium, cerium, hafnium, and combinations thereof.

25. The method of claim 21, wherein the metal organic framework is a zirconium metal organic framework or a zirconium-based metal organic framework further comprising hafnium.

26. The method of claim 21, wherein the solvent comprises at least one of a monocarboxylic acid and/or a mineral acid.

27. The method of claim 26, wherein the monocarboxylic acid is selected from the group consisting of acetic acid, formic acid, propionic acid, and mixtures thereof.

28. The method of claim 26, wherein the mineral acid is selected from the group consisting of hydrochloric acid, hydrobromic acid, and mixtures thereof.

29. The method of claim 27, wherein the solvent comprises a monocarboxylic acid and the amount (as mol ratio) of monocarboxylic acid to ligand in the reaction mixture is from 1:1 to 20:1.

30. The method of claim 21, wherein the solvent is added to the reaction mixture in an amount between 0.1 and 1.0 weight equivalents relative to the solid reactants.

31. The method of claim 21, further comprising adding a crystallization aid to the reaction mixture with the solvent, wherein the crystallization aid is a divalent metal selected from the group consisting of zinc, cobalt, tin, copper, and combinations thereof.

32. The method of claim 31, wherein the divalent metal source is a divalent metal oxide, chloride, bromide, acetate, formate, oxylate, nitrate, sulfate, and/or oxyanion salts thereof.

33. The method of claim 21, wherein the reaction mixture is heated to a temperature of between about 100° C. and 220° C.

34. The method of claim 21, wherein the metal organic framework is a Zr-terephthalate metal-organic framework or a Zr-fumarate metal-organic framework.

35. The method of claim 21, wherein the metal-organic framework is selected from UiO-66, EMM-71, zirconium fumarate, MOF-808, NU-1000, or a functionalized derivative thereof.

36. The method of claim 21, further comprising:
separating the insoluble portion from the soluble portion; and/or
drying the insoluble portion to produce a plurality of the metal-organic frameworks.

37. The method of claim 21, comprising:
combining a pre-ligand selected from esters of a terephthalate with a metal source comprising a tetravalent metal component to provide a plurality of solid reactants;
adding a solvent comprising a monocarboxylic acid and a crystallization aid comprising a divalent metal to the plurality of solids to form a reaction mixture having a mol ratio of monocarboxylic acid to ligand between 1:1 and 20:1, wherein at least 50 wt % of the reaction mixture are the plurality of solid reactants;
heating the reaction mixture to a temperature of between about 100° C. and about 220° C.;
cooling the reaction mixture to produce an insoluble portion and a soluble portion, wherein the insoluble portion comprises a plurality of the metal-organic frameworks, each metal-organic framework comprising the ligand and the metal component;
separating the insoluble portion from the soluble portion; and
drying the insoluble portion to produce a plurality of the metal-organic frameworks, wherein the reaction mixture does not comprise dimethylformamide.

38. The method of claim 37, wherein the crystallization aid is zinc oxide.

39. The method of claim 37, wherein the tetravalent metal component is selected from the group consisting of zirconium, hafnium or a mixture thereof.

40. The method of claim 37, wherein the metal-organic framework is selected from the group consisting of UiO-66, EMM-71, zirconium fumarate, MOF-808, NU-1000, or a functionalized derivative thereof.
